(19) United States
(12) Patent Application Publication
(10) Pub. No.: US 2018/0341764 A1
(43) Pub. Date: Nov. 29, 2018

(54) UNLOCKING METHOD AND ELECTRONIC DEVICE

(71) Applicant: PEGATRON CORPORATION, TAIPEI CITY (TW)

(72) Inventor: Yu-Wen Chou, Taipei City (TW)

(73) Assignee: PEGATRON CORPORATION, TAIPEI CITY (TW)

(21) Appl. No.: 15/990,556

(22) Filed: May 25, 2018

(30) Foreign Application Priority Data
May 26, 2017 (TW) 106117503

(51) Int. Cl. G06F 21/36; G06F 3/0486; G06F 3/0488

(52) U.S. Cl. CPC G06F 21/36; G06F 3/04883; G06F 3/0486

(57) ABSTRACT

An unlocking method and an electronic device are provided. The electronic device stores a predetermined color sequence. The unlocking method is adapted for an electronic device having a display interface. The method includes: defining a plurality of blocks on the display interface; randomly allocating a plurality of colors to be displayed to the blocks; receiving locations of a plurality of tapping operations to generate a color sequence according to the colors displayed on the blocks which are tapped; comparing the color sequence with the predetermined color sequence; unlocking the electronic device if the color sequence is the same as the predetermined color sequence.

### CROSS-REFERENCE TO RELATED APPLICATION

This application claims the priority benefit of Taiwan application serial no. 106117503, filed on May 26, 2017. The entirety of the above-mentioned patent application is hereby incorporated by reference herein and made a part of this specification.

### BACKGROUND

### Technical Field

The disclosure relates to an unlocking method and an electronic device; more particularly, the disclosure relates to an unlocking method and an electronic device that performs unlocking operations through unconventional methods.

### Description of Related Art

In order to confirm whether a person currently using an electronic device is a legitimate user, the electronic device may require the user to input a correct password to unlock or confirm the identity. Conventionally, a password including English, number, or symbol is input through a physical keyboard or a virtual keyboard, or whether the user is a legitimate user is determined by inputting the correct link of multiple points on the touch screen. In addition, it is also possible to use the user's biometrics, such as fingerprint recognition, iris recognition, and so on, so as to determine whether the user is a legitimate user.

Using a physical keyboard or a virtual keyboard to input a password including English, numbers, or symbols may cause more damages to certain keys of the physical keyboard than to other keys, or may shorten the lifetime of the touch function of some parts of the virtual keyboard much more than the other parts of the virtual keyboard. When it is determined whether the user is a legitimate user through inputting the correct pattern made by multiple points on the touch screen, the tapped points for performing the unlocking operation stay unchanged, and therefore other users may track the smears and smudges left on the screen during the tapping operations by the user and can then perform the unlocking operation. Performing the unlocking operation by virtue of the user's biometrics is not always successful and often influenced by physiological factors. For example, if the user catches a cold, voiceprint recognition may not be applied; alternatively, if the user is injured, he or she may not be able to perform the unlocking operation through fingerprint recognition. Hence, people skilled in the pertinent art should endeavor to figure out how to perform the unlocking operation in a more efficient matter.

### SUMMARY

The disclosure provides an unlocking method and an electronic device, which can perform unlocking operations by virtue of colors of blocks or vectors generated by input operations, so as to better ensure security of the unlocking operations.

In an embodiment of the invention, an unlocking method adapted for an electronic device having a display interface is provided. The electronic device stores a predetermined color sequence. The unlocking method includes: defining a plurality of blocks on the display interface. The unlocking method further includes: randomly allocating a plurality of colors to be displayed to the blocks. The unlocking method further includes: receiving locations of a plurality of tapping operations to generate a color sequence according to the colors displayed on the blocks which are tapped. The unlocking method further includes: comparing the color sequence with the predetermined color sequence. The unlocking method further includes: unlocking the electronic device if the color sequence is the same as the predetermined color sequence.

According to an embodiment, any two of the blocks in the blocks have different colors, and the number of colors is the same as the number of the blocks.

According to an embodiment, the step of defining the blocks on the display interface includes: randomly generating at least two straight lines on the display interface to partition the display interface into the blocks.

In an embodiment of the invention, an unlocking method adapted for an electronic device having a display interface is provided. The electronic device stores a predetermined vector sequence. The unlocking method includes: displaying a plurality of nodes on the display interface. The unlocking method further includes: receiving a plurality of input operations at the nodes to generate a vector sequence, wherein at least one of the input operations generates one vector of the vector sequence. The unlocking method further includes: comparing the vector sequence with the predetermined vector sequence. The unlocking method further includes: unlocking the electronic device if the vector sequence is the same as the predetermined vector sequence.

According to an embodiment, distances from each of the nodes to a center corresponding to the node are equal, and a location of the center is randomly generated on the display interface.

According to an embodiment, the input operations include a plurality of drag operations, each of the drag operations includes tapping one of the nodes and dragging the tapped node to another of the nodes, and each of the drag operations generates one vector in the vector sequence.

According to an embodiment, the input operations include a plurality of sets of tapping operations, each set of the tapping operations includes tapping a start node and an end node of the nodes, and each set of the tapping operations generates one vector in the vector sequence through tapping the start node and the end node.

According to an embodiment, the nodes include a central node, and distances from each of the nodes excluding the central node to the central node are equal. Here, each vector in the vector sequence may be a long vector or a short vector, the length of the long vector is greater than the distances from each of the nodes excluding the central node to the central node, and the length of the short vector is less than or equal to the distances from each of the nodes excluding the central node to the central node.

According to an embodiment, the nodes include a central block and a plurality of peripheral blocks surrounding the central block, wherein vectors in the vector sequence are generated by tapping the central block and dragging the tapped central block to one of the peripheral blocks.

According to an embodiment, the nodes include a central node and a reference node. Distances from each of the nodes excluding the central node and the reference node to the central node are equal, and a distance from the reference node to the central node is different from the distances from each of the nodes excluding the central node and the reference node to the central node. When the nodes are rotated on the display interface, the vector sequence is generated according to the reference node.

In another embodiment of the invention, an electronic device including a touch screen and a processor is provided. The electronic device stores a predetermined color sequence. The processor is coupled to the touch screen, a partition module, a configuration module, a sequence generation module, a comparison module, and a security module. The processor controls the partition module to define a plurality of blocks on the display interface. The processor controls the configuration module to randomly allocate a plurality of colors to be displayed to the blocks. When the touch screen receives locations of a plurality of tapping operations, the processor controls the sequence generation module to generate a color sequence according to the colors displayed on the blocks which are tapped. The processor controls the comparison module to compare the color sequence with the predetermined color sequence. The processor controls the security module to unlock the electronic device if the color sequence is the same as the predetermined color sequence.

According to an embodiment, any two of the blocks in the blocks have different colors, and the number of the colors is the same as the number of the blocks.

According to an embodiment, the processor randomly control the touch screen to generate least two straight lines on the display interface to partition the display interface into the blocks.

According to an embodiment, the partition module, the configuration module, the sequence generation module, the comparison module, and the security module may be integrated in the processor.

In another embodiment of the invention, an electronic device including a touch screen and a processor is provided. The electronic device stores a predetermined vector sequence. The processor is coupled to the touch screen, a node display module, a sequence generation module, a comparison module, and a security module. The processor controls the node display module to display a plurality of nodes on the display interface. The processor controls the sequence generation module to receive a plurality of input operations at the nodes to generate a vector sequence, and at least one of the input operations generates one vector of the vector sequence. The processor controls the comparison module to compare the vector sequence with the predetermined vector sequence. The processor controls the security module to unlock the electronic device if the vector sequence is the same as the predetermined vector sequence.

According to an embodiment, a distance from each of the nodes to a center corresponding to the node is equal, and a location of the center is randomly generated on the display interface.

According to an embodiment, the input operations include a plurality of drag operations, each of the drag operations includes tapping one of the nodes and dragging the tapped node to another of the nodes, and each of the drag operations generates one vector in the vector sequence.

According to an embodiment, the input operations include a plurality of sets of tapping operations, each set of the tapping operations includes tapping a start node and an end node of the nodes, and each set of the tapping operations generates one vector in the vector sequence through tapping the start node and the end node.

According to an embodiment, the nodes include a central node, and distances from each of the nodes excluding the central node to the central node is equal. Here, each vector in the vector sequence may be a long vector or a short vector, the length of the long vector is greater than the distances from each of the nodes excluding the central node to the central node, and the length of the short vector is less than or equal to the distances from each of the nodes excluding the central node to the central node.

According to an embodiment, the nodes include a central block and a plurality of peripheral blocks surrounding the central block, wherein vectors in the vector sequence are generated by tapping the central block and dragging the tapped central block to one of the peripheral blocks.

According to an embodiment, the nodes include a central node and a reference node. Distance from each of the nodes excluding the central node and the reference node to the central node is equal, and a distance from the reference node to the central node is different from the distances from each of the nodes excluding the central node and the reference node to the central node. When the nodes are rotated on the display interface, the vector sequence is generated according to the reference node.

According to an embodiment, the node display module, the sequence generation module, the comparison module, and the security module may be integrated in the processor.

In view of the above, the unlocking method and the electronic device provided herein may use the order in which the blocks with different colors are tapped as the unlocking password, and the colors of each block may be dynamically changed each time when the unlocking operation is performed, so as to avoid the touch function of the touch screen being deteriorated when over-tapping certain blocks. Besides, the unlocking method and the electronic device provided herein may utilize the nodes to generate a plurality of vectors as the unlocking password. This may also prevent the touch function of the touch screen from being deteriorated when over-tapping certain blocks.

To make the above features and advantages provided in one or more of the embodiments of the disclosure more comprehensible, several embodiments accompanied with drawings are described in detail as follows.

### BRIEF DESCRIPTION OF THE DRAWINGS

The accompanying drawings are included to provide a further understanding of the disclosure, and are incorporated in and constitute a part of this specification. The drawings illustrate embodiments of the disclosure and, together with the description, serve to explain the principles described herein.

FIG. 1 is a block view of an electronic device according to an embodiment of the invention.

FIG. 2A and FIG. 2B schematically illustrate an unlocking method according to an embodiment of the invention.

FIG. 3 schematically illustrates an unlocking method according to an embodiment of the invention.

FIG. 4 is a flowchart illustrating an unlocking method according to an embodiment of the invention.

FIG. 5 schematically illustrates an unlocking method according to an embodiment of the invention.

FIG. 6 schematically illustrates an unlocking method according to an embodiment of the invention.

FIG. 7 schematically illustrates an unlocking method according to an embodiment of the invention.

FIG. 8 schematically illustrates an unlocking method according to an embodiment of the invention.

FIG. 9A and FIG. 9B schematically illustrate an unlocking method according to an embodiment of the invention.

FIG. 10 is a flowchart illustrating an unlocking method according to an embodiment of the invention.

### DETAILED DESCRIPTION

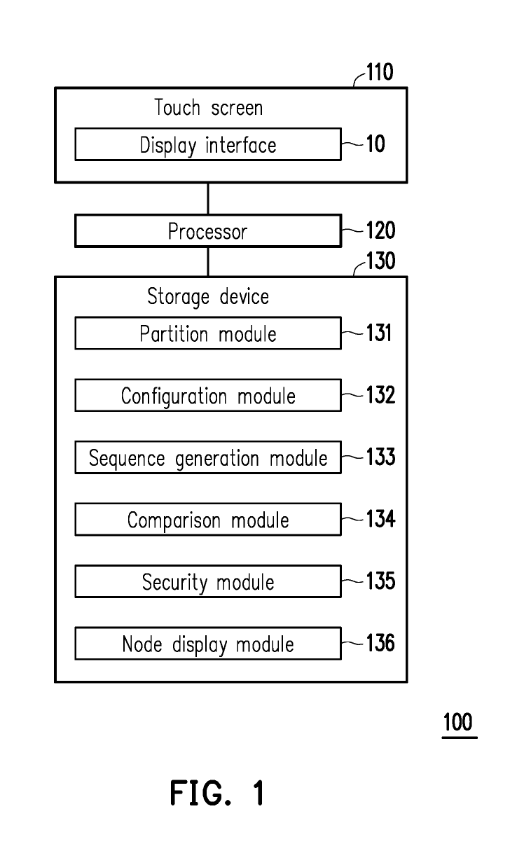

FIG. 1 is a block view of an electronic device according to an embodiment of the invention. With reference to FIG. 1, the electronic device 100 provided in the disclosure includes a touch screen 110, a processor 120, and a storage device 130. The touch screen 110 and the storage device 130 are coupled to the processor 120. The touch screen 110 may be a capacitive touch screen, a resistive touch screen, or any other type of touch screen, which should not be construed as a limitation in the disclosure. The touch screen 110 includes a display interface 10. The processor 120 may be a central processing unit (CPU), a programmable general-purpose or special-purpose microprocessor, a digital signal processor (DSP), a programmable controller, an application specific integrated circuit (ASIC), any other similar device, or a combination of said devices. The storage device 130 may be any type of fixed or movable random access memory (RAM), read-only memory (ROM), flash memory, hard disk drive (HDD), solid state drive (SSD), any other similar device, or a combination of said devices. The storage device 130 may include a partition module 131, a configuration module 132, a sequence generation module 133, a comparison module 134, a security module 135, and a node display module 136. The storage device 130 may also store a predetermined color sequence or a predetermined vector sequence which may be compared with the color sequence or the vector sequence input by the user, so as to determine whether the touch screen 110 is to be unlocked.

In an embodiment, the processor 120 controls the partition module 131 to define a plurality of blocks on the display interface 10. The processor 120 further controls the configuration module 132 to randomly allocate a plurality of colors to be displayed to the blocks. When the touch screen 110 receives locations of a plurality of tapping operations, the processor 120 controls the sequence generation module 133 to generate a color sequence according to the colors displayed on the blocks which are tapped. The processor 120 further controls the comparison module 134 to compare the color sequence with the predetermined color sequence. The processor 120 further controls the security module 135 to unlock the electronic device 100 if the color sequence is the same as the predetermined color sequence.

In an embodiment, the processor 120 controls the node display module 136 to define a plurality of nodes on the display interface 10. When a plurality of input operations are received at the nodes displayed on the touch screen 110, the processor 120 further controls the sequence generation module 133 to generate a vector sequence. The processor 120 further controls the comparison module 134 to compare the vector sequence with the predetermined vector sequence. The processor 120 further controls the security module 135 to unlock the electronic device 100 if the vector sequence is the same as the predetermined vector sequence.

Although the partition module 131, the configuration module 132, the sequence generation module 133, the comparison module 134, the security module 135, and the node display module 136 are implemented in the form of software module and are stored in the storage device 130, the disclosure is not limited thereto. In another embodiment, the partition module 131, the configuration module 132, the sequence generation module 133, the comparison module 134, the security module 135, and the node display module 136 may also be implemented in the form of hardware, such as a partition circuit, a configuration circuit, a sequence generation circuit, a comparison circuit, a security circuit, and a node display circuit which are either are integrated in the processor 120 or disposed separately from the processor 120.

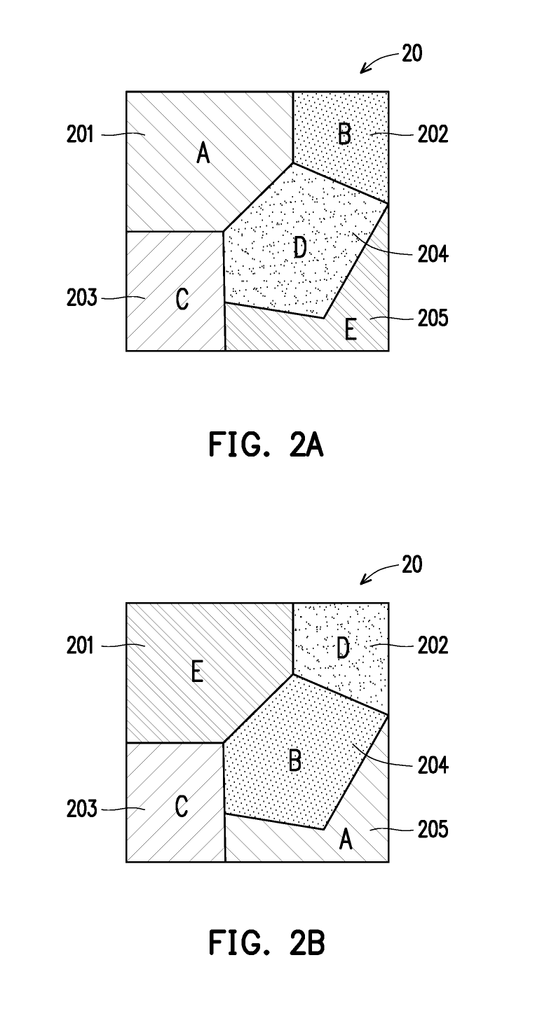

FIG. 2A and FIG. 2B schematically illustrate an unlocking method according to an embodiment of the invention.

As shown in FIG. 2A, on the lock screen, the processor 120 may define blocks 201-205 on the display interface 20 and randomly allocate colors A-E to be displayed to the blocks 201-205. For instance, the processor 120 may allocate the color A to be displayed to the block 201, allocate the color B to be displayed to the block 202, allocate the color C to be displayed to the block 203, allocate the color D to be displayed to the block 204, and allocate the color E to be displayed to the block 205. The user may sequentially tap the aforesaid blocks to generate a color sequence. For example, if the user taps the block 201, the block 203, the block 205, the block 202, and the block 204 in sequence, the processor 120 generates an “ACEBD” color sequence. Next, the processor 120 compares the color sequence with the predetermined color sequence stored in the storage device 130. If the color sequence is the same as the predetermined color sequence stored in the storage device 130, the processor 120 unlocks the electronic device 100. For instance, if the predetermined color sequence is also “ACEBD”, the user taps the above-mentioned block 201, block 203, block 205, block 202, and block 204 to unlock the electronic device 100. Although the letters A-E are used to represent different colors in the aforesaid embodiment, the disclosure is not limited thereto. For instance, the colors A-E may also be represented by numerical indexes 1-5, respectively. Thereby, in the above example, the color sequence of “ACEBD” may be stored with use of the “13524” as a numerical password.

Please refer to FIG. 2B, which shows a lock screen where another unlocking operation is performed at another time different from FIG. 2A. Although the arrangement positions of the blocks 201-205 are not changed, the color displayed by each block has changed. For instance, the blocks 201-205 have colors E, D, C, B, and A, respectively. Therefore, on this lock screen, to generate the color sequence of “ACEBD” in the above example, the user must tap the block 205, the block 203, the block 201, the block 204, and the block 202 in order to unlock the electronic device.

Although the blocks 201-205 have different colors in this embodiment, the disclosure is not limited thereto. According to another embodiment, two different blocks can have the same color; in this case, when the user performs the unlocking operation to generate the color sequence, different blocks may be tapped to generate the same color.

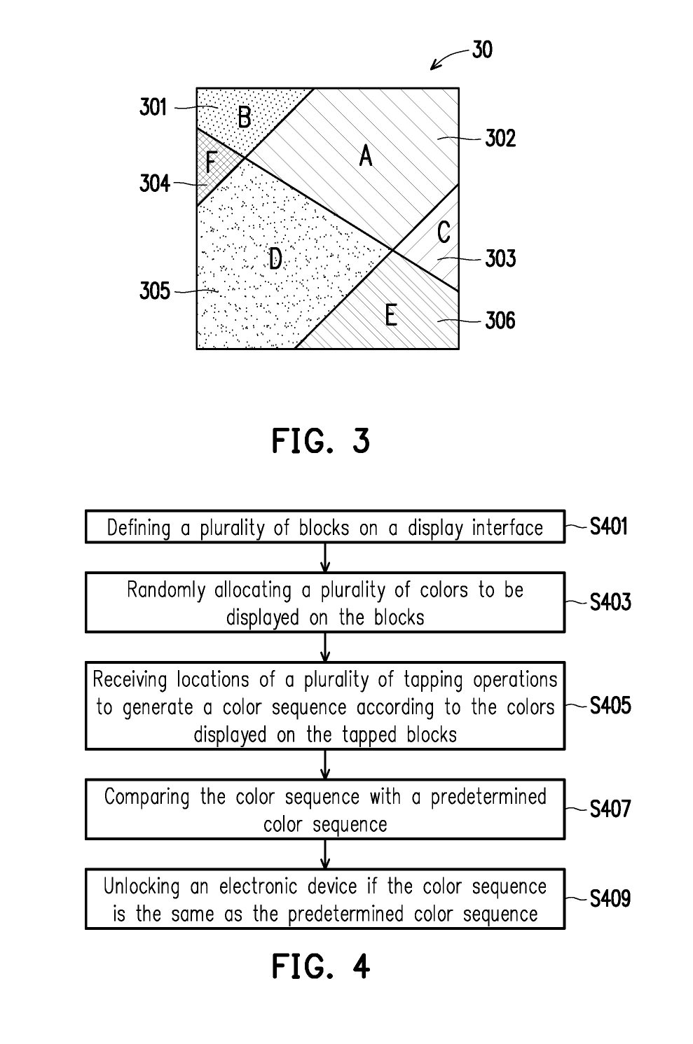

FIG. 3 schematically illustrates an unlocking method according to an embodiment of the invention.

On the lock screen, the processor 120 may randomly generate at least two straight lines to partition the display interface 30 into a plurality of blocks. For instance, in FIG. 3, the processor 120 may randomly generate three straight lines to partition the display interface 30 into blocks 301-306 and allocate the color B, the color A, the color C, the color F, the color D, and the color E to the blocks 301-306, respectively. If the predetermined color sequence stored in the storage device 130 is “ACEBDF”, the user must tap the block 302, the block 303, the block 306, the block 301, the block 305, and the block 304 in order to perform the unlocking operation. Note that the length of the predetermined color sequence does not have to be equal to the number of blocks; that is, the length of the predetermined color sequence may be the length of five colors, the length of four colors, or the length of another number of colors.

Although in the present embodiment, the straight lines that partition the display interface 10 into a plurality of blocks are randomly generated by the processor 120, the disclosure is not limited thereto. In another embodiment, plural lines partitioning the display interface 10 into plural blocks may also be drawn on the display interface 10 by the user through the touch screen 110 when the predetermined color sequence is set. After the user draws the straight lines, the processor 120 allocates colors to be displayed to the blocks partitioned by the straight lines. When the user inputs the color sequence for performing the unlocking operation, the same block partition that is originally set at the same time as the color sequence is set for performing the unlocking operation is displayed.

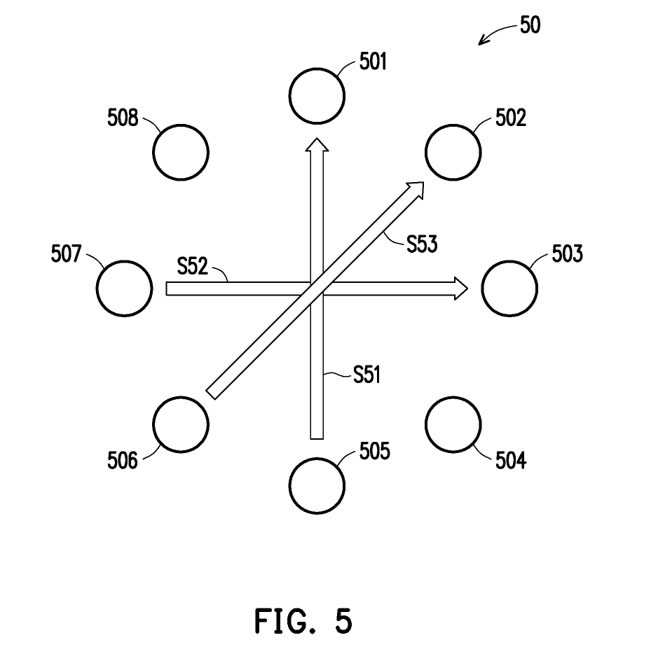

FIG. 4 is a flowchart illustrating an unlocking method according to an embodiment of the invention.

With reference to FIG. 4, in step S401, plural blocks are defined on the display interface 10. In step S403, plural colors are randomly displayed on the blocks. In step S405, locations of a plurality of tapping operations are received to generate a color sequence according to the colors displayed on the blocks which are tapped. In step S407, the color sequence is compared with the predetermined color sequence. In step S409, if the color sequence is the same as the predetermined color sequence, the electronic device 100 is unlocked.

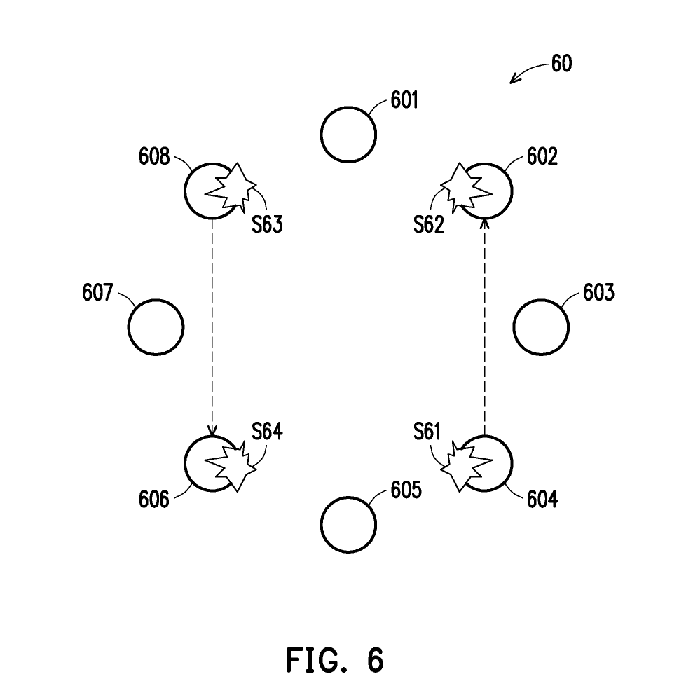

FIG. 5 schematically illustrates an unlocking method according to an embodiment of the invention.

With reference to FIG. 5, on the lock screen, the processor 120 may display the nodes 501-508 on the display interface 50 and receive a plurality of input operations at the nodes 501-508 to generate a vector sequence. For instance, the user may perform an input operation S51 (i.e., tap the node 505 and drag the tapped node 505 to the node 501) to generate an “up” vector, subsequently perform an input operation S52 (i.e., tap the node 507 and drag the tapped node 507 to the node 503) to generate a “right” vector, and then perform an input operation S53 (i.e., tap the node 506 and drag the tapped node 506 to the node 502) to generate an “upper-right” vector. Finally, an “up, right, upper-right” vector sequence is generated. The processor 120 may compare whether the “up, right, upper-right” vector sequence is the same as the predetermined vector sequence stored in the storage device 130. If the “up, right, upper-right” vector sequence is the same as the predetermined vector sequence stored in the storage device 130, the electronic device 100 is unlocked.

The size and position of the circle made by the nodes 501-508 may be arbitrarily displayed on the display interface 50; however, it should be ensured that all the nodes 501-508 are correctly displayed on the display interface 50, and no node collides with adjacent nodes. Besides, in the present embodiment, the vector between any two nodes can be interpreted as one of “up”, “down”, “left”, “right”, “upper-right”, “upper-left”, “lower-right”, and “lower-left”, so as to reduce the difficulty for the user to memorize the vector sequence. For instance, the vector that is dragged from the node 505 to the node 504 and the vector that is dragged from the node 504 to the node 503 may be interpreted as an “upper-right” vector. The vector that is dragged from the node 504 to the node 501 and the vector that is dragged from the node 504 to the node 507 may be interpreted as an “upper-left” vector, and the rest may be deduced therefrom in the same manner. In addition, in this embodiment, 8 nodes are applied to generate the vector sequence, while the disclosure should not be limited thereto. In another embodiment, 6, 4, or any number of nodes may be applied to generate the vector sequence. The way to interpret the vector may also be slightly modified with the changes to the number of nodes.

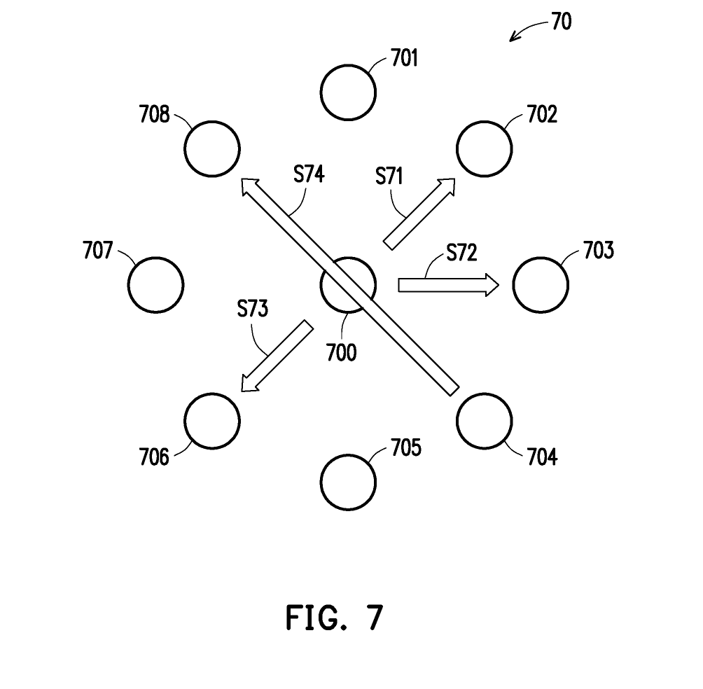

FIG. 6 schematically illustrates an unlocking method according to an embodiment of the invention.

With reference to FIG. 6, on the lock screen, the processor 120 may display the nodes 601-608 on the display interface 60, receive the input operations, and sequentially touch the nodes to generate a vector sequence.

The difference between the present embodiment and the embodiment shown in FIG. 5 is how the vector is generated by the user. Specifically, according to the embodiment shown in FIG. 5, one vector is generated by tapping a node and dragging the tapped node to another node. By contrast, in the present embodiment, one vector is generated by a set of tapping operations. For instance, the user may perform an input operation S61 by tapping the node 604 and then perform an input operation S62 by tapping the node 602. Here, the nodes 604 and 602 are the start node and the end node of the first set of tapping operations. Through the first set of tapping operations, an “up” vector is generated. Similarly, the user may then perform an input operation S63 by tapping the node 608 and perform an input operation S64 by tapping the node 606. Here, the nodes 608 and 606 are the start node and the end node of the second set of tapping operations. Through the second set of tapping operations, a “down” vector is generated. Through the first and second sets of tapping operations, an “up, down” vector sequence may be generated. The processor 120 then compares the “up, down” vector sequence with the predetermined vector sequence stored in the storage device 130 to determine whether these two vector sequences are the same. If the “up, down” vector sequence is the same as the predetermined vector sequence stored in the storage device 130, the electronic device 100 is unlocked.

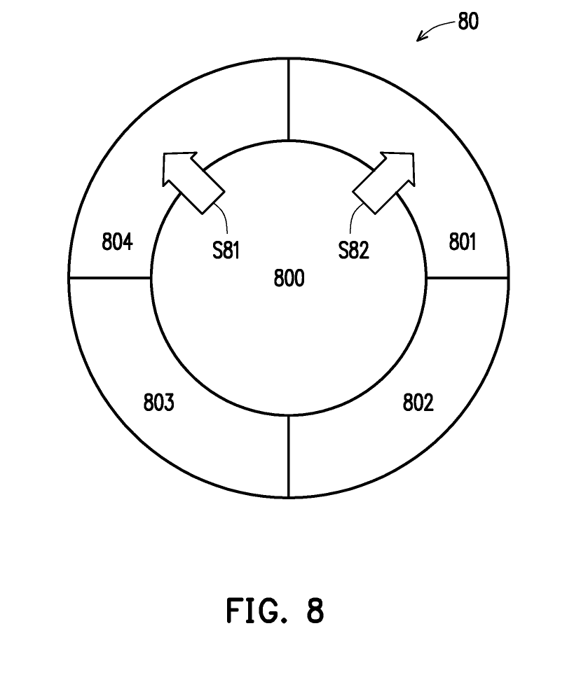

FIG. 7 schematically illustrates an unlocking method according to an embodiment of the invention.

With reference to FIG. 7, on the lock screen, the processor 120 may display the nodes 700-708 on the display interface 70, receive the input operations, and sequentially touch the nodes to generate a vector sequence. Here, the node 700 is a central node. If the length of one vector is greater than the distance from the node 700 to the node 701, the vector may be defined as a long vector. On the contrary, if the length of one vector is less than the distance from the node 700 to the node 701, the vector may be defined as a short vector. The central node, i.e., the node 700, may be randomly generated anywhere on the display interface 70, given that all of the nodes 701-708 are also generated on the display interface 70.

For instance, the user may perform an input operation S71 by tapping the node 700 and dragging the tapped node 700 to the node 702, so as to generate a “short upper-right” vector. The user may then perform an input operation S72 by tapping the node 700 and dragging the tapped node 700 to the node 703, so as to generate a “short right” vector. The user may then perform an input operation S73 by tapping the node 700 and dragging the tapped node 700 to the node 706, so as to generate a “short lower-left” vector. The user may then perform an input operation S74 by tapping the node 704 and dragging the tapped node 704 to the node 708, so as to generate a “long upper-left” vector. Finally, a “short upper-right, short right, short lower-left, long upper-left” vector sequence is generated. The processor 120 may compare whether the “short upper-right, short right, short lower-left, long upper-left” vector sequence is the same as the predetermined vector sequence stored in the storage device 130. If the “short upper-right, short right, short lower-left, long upper-left” vector sequence is the same as the predetermined vector sequence stored in the storage device 130, the electronic device 100 is unlocked. The vectors in the vector sequence could be long or short vectors.

Similar to the embodiment shown in FIG. 5, the vector generated by dragging the node 704 to the node 702 may be interpreted as a “long up” vector, the vector generated by dragging the node 705 to the node 706 may be interpreted as a “short upper-left” vector, the vector generated by dragging the node 704 to the node 707 may be interpreted as a “long upper-left” vector, and so on.

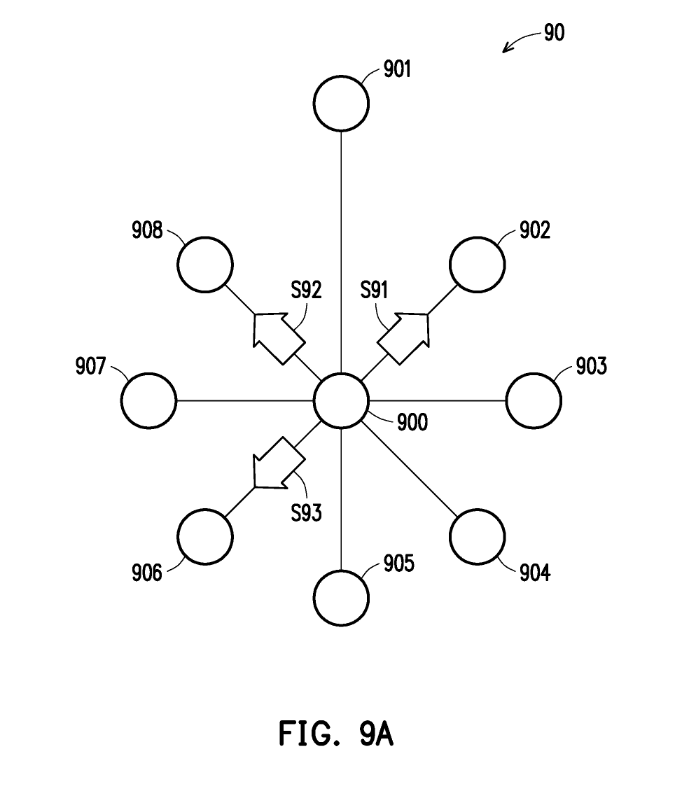

FIG. 8 schematically illustrates an unlocking method according to an embodiment of the invention.

With reference to FIG. 8, on the lock screen, the processor 120 may display the nodes 800-804 on the display interface 80 and receive a plurality of input operations at the nodes 800-804 to generate a vector sequence. For instance, the user may perform an input operation S81 by tapping the node 800 and dragging the tapped node 800 to the node 804, so as to generate an “upper-right” vector. The user may then perform an input operation S82 by tapping the node 800 and dragging the tapped node 800 to the node 801, so as to generate an “upper-right” vector. Finally, an “upper-left, upper-right” vector sequence is generated. The processor 120 may compare whether the “upper-left, upper-right” vector sequence is the same as the predetermined vector sequence stored in the storage device 130. If the “upper-left, upper-right” vector sequence is the same as the predetermined vector sequence stored in the storage device 130, the electronic device 100 is unlocked.

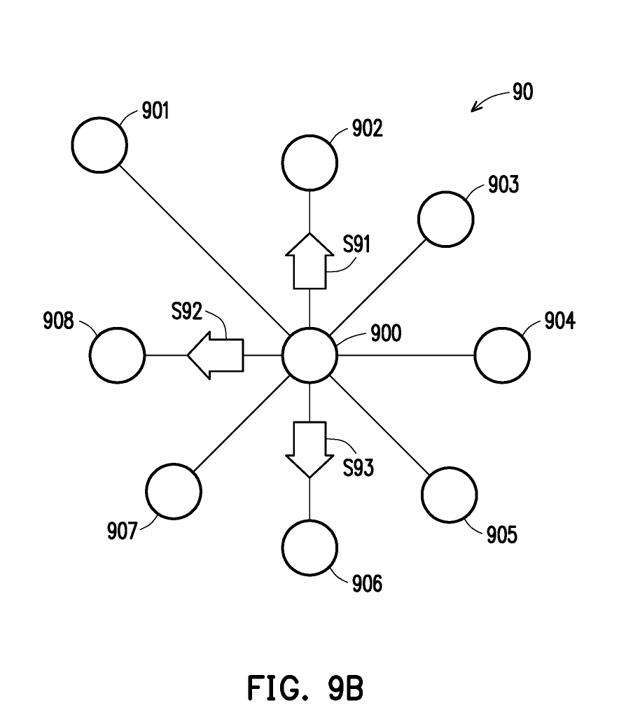

FIG. 9A and FIG. 9B schematically illustrate an unlocking method according to an embodiment of the invention.

With reference to FIG. 9A, on the lock screen, the processor 120 may display the nodes 900-908 on the display interface 90 and receive a plurality of input operations at the nodes 900-908 to generate a vector sequence. Here, the node 900 is a central node, and the node 901 is a reference node. A distance from the reference node 901 to the central node 900 is different from the distances from each of the nodes 902-908 to the central node 900. In the present embodiment, the distance from the reference node 901 to the central node 900 is longer than the distance from each of the nodes 902-908 to the central node 900. According to the present embodiment, the vector from the node 900 to the node 901 is considered a norm or is a “north” vector. The “north” is merely a reference direction of the vector and does not refer to the geographical north or the magnetic north. Hence, when the user performs the input operations S91, S92, and S93, a “northeast, northwest, southwest” vector relative to “north” is generated. Every time when entering the lock screen, all of the nodes 901-908 are rotated relative to the node 900 by a random angle, as shown in FIG. 9B. At this moment, the user should first determine the norm (i.e., the “north”) by virtue of the node 901 far spaced from the node 900, and perform the input operations S91, S92, and S93 sequentially to generate a “northeast, northwest, southwest” vector sequence and unlock the electronic device 100.

Similar to the embodiment shown in FIG. 5, the size and position of the circle made by the nodes 900-908 may be arbitrarily displayed on the display interface 90; however, it should be ensured that all the nodes 900-908 are correctly displayed on the display interface 90, and no node collides with the adjacent nodes.

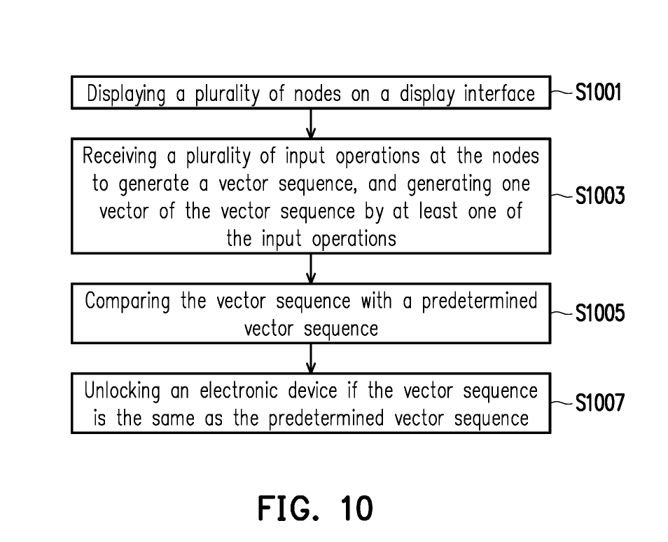

FIG. 10 is a flowchart illustrating an unlocking method according to an embodiment of the invention.

With reference to FIG. 10, in step S1001, plural nodes are displayed on the display interface 10. In step S1003, a plurality of input operations is received at the nodes to generate a vector sequence, and at least one of the input operations generates one vector of the vector sequence. In step S1005, the vector sequence is compared with the predetermined vector sequence. In step S1007, if the vector sequence is the same as the predetermined vector sequence, the electronic device 100 is unlocked.

To sum up, the unlocking method and the electronic device provided herein may use the order in which the blocks with different colors are tapped as the unlocking password, and the colors of each block may be dynamically changed each time when the unlocking operation is performed, so as to avoid the touch function of the touch screen being deteriorated when over-tapping certain blocks. Besides, the unlocking method and the electronic device provided herein may utilize the nodes to generate a plurality of vectors as the unlocking password. This may also prevent the touch function of the touch screen from being deteriorated when over tapping certain blocks. Moreover, it is rather unlikely for the subsequent user to perform the unlocking operation by virtue of remnants left behind by the previous user.

It will be apparent to those skilled in the art that various modifications and variations can be made to the structure described in the disclosure without departing from the scope or spirit of the disclosure. In view of the foregoing, it is intended that the disclosure cover modifications and variations provided they fall within the scope of the following claims and their equivalents.

What is claimed is:

1. An unlocking method adapted for an electronic device having a display interface, the electronic device storing a predetermined color sequence, the unlocking method comprising:
defining a plurality of blocks on the display interface;
randomly allocating a plurality of colors to be displayed to the plurality of blocks;
receiving locations of a plurality of tapping operations to generate a color sequence according to the plurality of colors displayed on the plurality of blocks which are tapped;
comparing the color sequence with the predetermined color sequence; and
unlocking the electronic device if the color sequence is the same as the predetermined color sequence.

2. The unlocking method as recited in claim 1, wherein any two of the plurality of blocks have different colors, and the number of the colors is the same as the number of the plurality of blocks.

3. The unlocking method as recited in claim 1, wherein the step of defining the plurality of blocks on the display interface comprises randomly generating at least two straight lines on the display interface to partition the display interface into the plurality of blocks.

4. An unlocking method adapted for an electronic device having a display interface, the electronic device storing a predetermined vector sequence, the unlocking method comprising:
displaying a plurality of nodes on the display interface;
receiving a plurality of input operations at the plurality of nodes to generate a vector sequence, at least one of the plurality of input operations generating one vector of the vector sequence;
comparing the vector sequence with the predetermined vector sequence; and
unlocking the electronic device if the vector sequence is the same as the predetermined vector sequence.

5. The unlocking method as recited in claim 4, wherein distances from each of the plurality of nodes to a center corresponding to the each of the plurality of nodes are equal, and a location of the center is randomly generated on the display interface.

6. The unlocking method as recited in claim 4, the plurality of input operations comprising a plurality of drag operations, each of the plurality of drag operations comprising tapping one of the nodes and dragging the tapped node to another of the plurality of nodes, each of the drag operations generating one vector in the vector sequence.

7. The unlocking method as recited in claim 4, the plurality of input operations comprising a plurality sets of tapping operations, each set of the plurality of tapping operations comprising tapping a start node and an end node of the plurality of nodes, and each set of the plurality of tapping operations generating one vector in the vector sequence through tapping the start node and the end node.

8. The unlocking method as recited in claim 4, the plurality of nodes comprising a central node, distances from each of the plurality of nodes excluding the central node to the central node being equal, wherein each vector in the vector sequence is a long vector or a short vector, the length of the long vector is greater than the distances from each of the plurality of nodes excluding the central node to the central node, and the length of the short vector is less than or equal to the distances from each of the plurality of nodes excluding the central node to the central node.

9. The unlocking method as recited in claim 4, the plurality of nodes comprising a central block and a plurality of peripheral blocks surrounding the central block, wherein vectors in the vector sequence are generated by tapping the central block and dragging the tapped central block to one of the plurality of peripheral blocks.

10. The unlocking method as recited in claim 4, the plurality of nodes comprising a central node and a reference node, distances from each of the plurality of nodes excluding the central node and the reference node to the central node being equal, a distance from the reference node to the central node being different from the distances from each of the plurality of nodes excluding the central node and the reference node to the central node, when the plurality of nodes being rotated on the display interface the vector sequence being generated according to the reference node.

11. An electronic device storing a predetermined color sequence and comprising:
a touch screen comprising a display interface; and
a processor coupled to the touch screen and a partition module, a configuration module, a sequence generation module, a comparison module, and a security module,
the processor controlling the partition module to define a plurality of blocks on the display interface;
the processor controlling the configuration module to randomly allocate a plurality of colors to be displayed to the plurality of blocks;
the processor controlling the sequence generation module to generate a color sequence according to the plurality of colors displayed on the plurality of blocks which are tapped when the touch screen receives locations of a plurality of tapping operations;
the processor controlling the comparison module to compare the color sequence with the predetermined color sequence; and
the processor controlling the security module to unlock the electronic device if the color sequence is the same as the predetermined color sequence.

12. The electronic device as recited in claim 11, wherein any two of the plurality of blocks have different colors, and the number of the colors is the same as the number of the plurality of blocks.

13. The electronic device as recited in claim 11, wherein the processor randomly control the touch screen to generate at least two straight lines on the display interface to partition the display interface into the plurality of blocks.

14. The electronic device as recited in claim 11, wherein the partition module, the configuration module, the sequence generation module, the comparison module, and the security module are integrated in the processor.

15. An electronic device storing a predetermined vector sequence and comprising:
a touch screen comprising a display interface;
a processor coupled to the touch screen and a node display module, a sequence generation module, a comparison module, and a security module,
the processor controlling the node display module to display a plurality of nodes on the display interface;
the processor controlling the sequence generation module to receive a plurality of input operations at the plurality of nodes to generate a vector sequence, at least one of the plurality of input operations generating one vector of the vector sequence;
the processor controlling the comparison module to compare the vector sequence with the predetermined vector sequence; and
the processor controlling the security module to unlock the electronic device if the vector sequence is the same as the predetermined vector sequence.

16. The electronic device as recited in claim 15, wherein distances from each of the plurality of nodes to a center corresponding to the each of the plurality of nodes are equal, and a location of the center is randomly generated on the display interface.

17. The electronic device as recited in claim 15, the plurality of input operations comprising a plurality of drag operations, each of the plurality of drag operations comprising tapping one of the nodes and dragging the tapped node to another of the plurality of nodes, each of the drag operations generating one vector in the vector sequence.

18. The electronic device as recited in claim 15, the plurality of input operations comprising a plurality of sets of tapping operations, each set of the plurality of tapping operations comprising tapping a start node and an end node of the plurality of nodes, and each set of the plurality of tapping operations generating one vector in the vector sequence through tapping the start node and the end node.

19. The electronic device as recited in claim 15, the plurality of nodes comprising a central node, distances from each of the plurality of nodes excluding the central node to the central node being equal, wherein each vector in the vector sequence is a long vector or a short vector, the length of the long vector is greater than the distance from each of the plurality of nodes excluding the central node to the central node, and the length of the short vector is less than or equal to the distance from each of the plurality of nodes excluding the central node to the central node.

20. The electronic device as recited in claim 15, the plurality of nodes comprising a central block and a plurality of peripheral blocks surrounding the central block, wherein vectors in the vector sequence are generated by tapping the central block and dragging the tapped central block to one of the plurality of peripheral blocks.

21. The electronic device as recited in claim 15, the plurality of nodes comprising a central node and a reference node, a distance from each of the plurality of nodes excluding the central node and the reference node to the central node being equal, a distance from the reference node to the central node being different from the distance from each of the plurality of nodes excluding the central node and the reference node to the central node, when the plurality of nodes being rotated on the display interface, the vector sequence being generated according to the reference node.

22. The electronic device as recited in claim 15, wherein the node display module, the sequence generation module, the comparison module, and the security module are integrated in the processor.
